(19) United States
(12) Patent Application Publication
(10) Pub. No.: US 2023/0130492 A1
(43) Pub. Date: Apr. 27, 2023

(54) Device and Method for the Production or Management of a Powder Mixture, Additive Manufacturing Method and Powder Mixture

(71) Applicant: Volkmann GmbH, Soest (DE)

(72) Inventor: Christopher Tegelkamp, Buren (DE)

(21) Appl. No.: 17/945,533

(22) Filed: Sep. 15, 2022

(30) Foreign Application Priority Data
Sep. 20, 2021 (DE) 10 2021 004 708.7

(51) Int. Cl. B22F 12/57; B33Y 10/00; B33Y 30/00; B33Y 50/02; B33Y 40/00

(52) U.S. Cl. CPC B22F 12/57; B33Y 10/00; B33Y 30/00; B33Y 50/02; B33Y 40/00

(57) ABSTRACT

The invention relates to a device (1) for the production, in particular the production and metering, of a powder mixture for an additive manufacturing process. The powder mixture for the additive manufacturing process comprises a first powder arranged in a first container (2), and at least one further, in particular a second, powder arranged in at least one further, in particular a second, container (2′). An inlet of a first means of powder transport and/or metering (4) is arranged at the outlet (6) of the first container (2), and an inlet of a further, in particular a second, means of powder transport and/or metering (4′), is arranged at the outlet (6′) of the further, in particular the second, container (2′). The first powder can be supplied by means of the first means of transport and/or metering (4) and the further, in particular the second, powder can be supplied by means of the further, in particular the second, means of transport and/or metering (4′), in each case in a controlled manner, in particular in a controllable and/or regulatable manner, to at least one mixing container (5), preferably comprising at least one screen (10). The outlet (7) of the first means of transport and/or metering (4) and the outlet (7′) of the further, in particular the second, means of transport and/or metering (4′) are arranged in or above the mixing container (5) above each other, or next to each other, preferably above each other, or next to each other, and in each case above the screen (10).

### FIELD OF THE INVENTION

The invention relates to a device for the production, in particular the production and metering, of a powder mixture for an additive manufacturing process, in accordance with the preamble of claim 1. Accordingly, the powder mixture for the additive manufacturing process comprises a first powder arranged in a first container, and at least one further powder arranged in at least one further container, in particular a second powder arranged in a second container. A third container for a third powder can be provided, and, if so required, a fourth container for a fourth powder, and further containers for further powders. The more containers/powders that are provided, the more are the powder mixtures and formulations that can be produced with the device. First and further (second, third, . . . ) powders can differ in the material composition or in the granulate size. The first powder can be an unused (“new”) powder, in the form in which the powder manufacturer places the powder on the market, and the further (second, third, . . . ) powders can be an already used powder, for example a recycled powder, which has been left as a residue or surplus in the course of an additive manufacturing process. The first powder can be created from a first metal, or a first metal compound, and the further (second, third, . . . ) powder can be created from a further (second, third, . . . ) metal, or a further (second, third, . . . ) metal compound. In what follows, the term “second” container or “second” powder can also include a further container or a further powder, such that the features described and claimed are not limited to a first and an ‘exclusively’ second container, or to a first and an ‘exclusively’ second powder.

The invention further relates to a device for the management of a powder or powder mixture for the additive manufacture of a manufactured part according to claim 10. The device comprises at least one powder conveying unit, which supplies the powder or the powder mixture to at least one container, and/or at least one powder processing unit, in which the powder or the powder mixture is processed by means of additive manufacture.

The invention further relates to a method for the production of a powder mixture according to claim 11, and to a use of vibrating means of transport and/or metering according to claim 18. Finally, the invention relates to a method for the additive manufacture of a manufactured part by means of a powder or a powder mixture according to claim 19, and to a powder mixture in accordance with the preamble of claim 20.

### TECHNOLOGICAL BACKGROUND

In additive manufacture, (metal) powders are regularly used as a production raw material. The powder is supplied to a powder processing unit by means of a powder conveying unit. Mixtures of powders are increasingly required for the processing. The powder mixtures are mixed in an upstream mixing process, wherein a first and at least one further, in particular a second, powder are mixed in a mixing container by means of agitation, and are then temporarily stored in a storage container. In this respect, the management of powder mixtures is time-consuming and cost-intensive. This is where the invention comes into play.

### PRESENTATION OF THE INVENTION

The invention is based on the object of simplifying the management of the powder and making it more efficient. This object is achieved by a device according to claim 1. Further configurations are the subject matter of the subsidiary claims. In the device for the production of a powder mixture comprising a first (unused) powder and a further, in particular a second, (used or recycled) powder, an inlet of a first means of powder transport and/or metering is arranged at the outlet of the first container, and an inlet of a further, in particular a second, means of powder transport and/or metering is arranged at the outlet of the further, in particular the second, container. A means of powder transport and/or metering can be a channel, or a duct, or any desired conveying unit. A means of powder metering can comprise a channel, or a duct, or a controllable conveying unit, or a valve, or a comparable controllable means of quantity or volume limitation. A means of powder transport and/or metering can comprise, or can be created from, a channel, a duct, a controllable conveying unit, and/or a controllable valve. The first powder can be supplied by means of the first means of transport and/or metering, and the second powder can be supplied by means of the second means of transport and/or metering, in each case in a controlled manner, in particular in a controllable and/or regulatable manner, to at least one mixing container, preferably comprising at least one screen. The outlet of the first means of transport and/or metering, and the outlet of the further, in particular the second, means of transport and/or metering, are arranged in or above the mixing container above each other or next to each other, preferably above each other or next to each other, and in each case above the screen. The powder or the powder mixture can comprise a metal powder or a metal powder mixture, or can comprise, or can be created from, a plastic material. The powder can also be created from other materials, such as ceramic materials or any desired materials or material compounds, depending on the specifications of the additive manufacturing method.

If the outlets are arranged next to each other, an arrangement in accordance with a Y-shaped geometry is expedient, that is to say, first and further, in particular second, outlets open into a common inlet of the mixing container. The feed rates of first and further, in particular second, powders are brought together in the common inlet.

With the device as described herein, a mixing unit, in particular one external to the process, for the production of a powder mixture for the additive manufacture becomes unnecessary. With the device as described, the powder can be mixed and/or metered in the ongoing production or powder management process, without having first to remove it from the process, then mix it externally, and then supply it back into the process.

Since the means of transport and/or metering participate in the metering or mixing process, no additional unit is required for the mixing. The device can be integrated with little effort into an existing powder management unit for additive manufacture, in particular into the ongoing process. The powder is always arranged in containers for the additive manufacture, and is always conveyed to the manufacturing equipment by means of transport units. The arrangement in accordance with the invention combines the conveyance of two or a plurality of powders, and a mixing and metering function of the conveying components, in particular within the (powder management or additive manufacturing) process can be implemented, preferably without interrupting the material flow, with little equipment expenditure.

The outlet of the first means of transport and/or metering can advantageously be arranged above the further, in particular the second, means of transport and/or metering, in particular above the outlet of the further, in particular the second, means of transport and/or metering, such that the first powder in the mixing container falls in a controlled manner, in particular in a controllable and/or regulatable manner, onto the outlet of the further, in particular the second, means of transport and/or metering, or into the region of the outlet of the further, in particular the second, means of transport and/or metering. The first and the further, in particular the second, powder thus fall in a controlled manner onto the screen, where a further mixing of the powders takes place. The quantity of the first powder is controlled with the first means of transport and/or metering, and the quantity of the further, in particular the second, powder is controlled with the further, in particular the second, means of transport and/or metering.

The first and/or the further, in particular the second, means of transport and/or metering can preferably be designed as a vibrating channel or a vibrating duct, or as a vibrating metering channel or a vibrating metering duct. The means of transport and/or metering can be driven, or can be controlled and/or regulated, separately. Each means of transport and/or metering preferably has its own (motorised) drive. It is expedient if the channels or ducts of the means of transport and/or metering have a slight slope, namely towards the outlet side.

The quantity of the first powder supplied to the mixing container can be controlled, in particular can be controlled and/or regulated, by the vibrational excitation of the first means of transport and/or metering. The quantity of the further, in particular the second, powder supplied to the mixing container can be controlled, in particular can be controlled and/or regulated, by the vibrational excitation of the further, in particular the second, means of transport and/or metering, independently of that of the first means of transport and/or metering.

Viewed in the direction of transport, at least one vibration-decoupling unit can be arranged in front of, or at the inlet of, the first and/or the further, in particular the second, means of transport and/or metering. By decoupling the vibrations excited in the device, the transmission of any vibrational excitation from one component of the device (for example from the first means of transport and/or metering) to another equipment component (for example to the further, in particular the second, means of transport and/or metering) is avoided. In this way, the material flow rate of one of the means of transport and/or metering involved can be reduced to zero, or almost zero, in particular if only one of the two powders is to enter into the mixing container at certain times. For example, if a mixing ratio of 100:1 is to be achieved (100 parts of a first (new) powder to 1 part of a further (second) (recycled) powder), one of the means of transport and/or metering (the further/second) is operated with a lower (vibrational) excitation than the other means of transport and/or metering (the first), and when the smaller proportion of the one powder component (further/second powder) is completely contained in the mixing container, the relevant means of transport and/or metering (the further/second means of transport and/or metering) is deactivated. The fact that the other, continuing means of transport and/or metering (the first means of transport and/or metering) does not transmit its vibration to the means of transport and/or metering (the second means of transport and/or metering) that is stationary after the desired delivery quantity has been reached, is achieved by one or a plurality of vibration-decoupling units. The vibration-decoupling unit can be designed as a compensator. Moreover, at least one vibration-decoupling unit can be arranged behind, or at the outlet of, the first and/or the further, in particular the second, means of transport and/or metering, as viewed in the direction of transport.

In this respect, mixing can take place in that the plurality of powders, or the two powders, enter into the mixing container one after the other and are thoroughly mixed there, or in that mixing of the powders can already take place by controlled metering by means of the means of transport and/or metering, before or as they enter the mixing container, so that it is just a homogenisation of the powder mixture that takes place in the mixing container.

The screen in the mixing container can be designed as a vibrating screen, which can be subjected to a vibrational excitation in a controllable manner, in particular in a controllable and/or regulatable manner. The vibration in the mixing container can optimise the mixing of the powder mixture components (a first and a further, in particular a second, powder). Moreover, the vibrational excitation in the mixing container ensures that the powder mixture is evenly distributed in the container, and that any accumulations, or lumps, or congestions, are avoided.

In accordance with an advantageous configuration of the device, and with a view to the further management of the powder mixture, the mixing container can have an outlet for the powder mixture, in particular an outlet for the powder mixture, and a further outlet for material captured by the screen, such as an outlet for oversized granulates.

In addition to the amplitude and frequency of the respective vibrational excitations, the powder or container weight can be an important parameter for the control or regulation of the mixing process. If a container is not sufficiently filled, for example, the desired mixing ratio cannot be achieved. Furthermore, the monitoring of the fill level of the container (the powder weight) is a measure for the respective material flow rate in the device. In this respect, it can be expedient for the first and/or the second container to have a weighing device for recording the weight of the container contents.

Simplified and efficient powder management is further achieved with a device according to claim 10. The device is provided for the management of a powder or a powder mixture for the additive manufacture of a manufactured part. The device comprises at least one powder conveying unit, which supplies the powder or the powder mixture to at least one container, and/or to at least one powder processing unit, in which the powder or the powder mixture is processed by means of additive manufacture. The powder conveying unit comprises a device as described herein for the production/metering of a powder mixture for an additive manufacturing process, or is created from the latter.

Simplified and efficient powder management is further achieved with a method according to claim 11. The method is for the production of a powder mixture, which comprises a first, in particular an unused, powder for an additive manufacturing process and at least one further, in particular a second, in particular an already used and/or recycled, powder for an additive manufacturing process. By means of a first means of transport and/or metering, the quantity of the first powder is controlled, in particular is controlled and/or regulated, and by means of at least one further, in particular a second, means of transport and/or metering, the quantity of the further, in particular the second, powder is controlled, in particular is controlled and/or regulated. The outlet of the first means of transport and/or metering is arranged above the further, in particular the second, means of transport and/or metering, in particular above the outlet, or in the region of the outlet, of the second means of transport and/or metering, such that the first and the further, in particular the second, powders enter in a controlled manner, in particular in a controlled and/or regulated manner, into a mixing container arranged below the outlet of the further, in particular the second, means of transport and/or metering, in particular such that they fall into the latter. The first powder falls, as it were, into the conveying path of the further, in particular the second, powder.

The first and/or the further, in particular the second, means of transport and/or metering can be designed as a vibrating channel, or a vibrating duct, in particular one that can be driven by an electric motor. The metering of the first and/or the further, in particular the second, powder can thus be controlled, in particular can be controlled and/or regulated, by the vibrational excitation of the first and/or the further, in particular the second, means of transport and/or metering. The vibrating channel or the vibrating duct can be designed as a metering channel or a metering duct.

At least one screen can be arranged in the mixing container, in particular at least one vibrating screen (which can be driven by an electric motor). The drives of the vibrating units can be controlled/regulated independently of each other. A mixing of the powders that is as homogeneous as possible is preferably controlled, in particular is preferably controlled and/or regulated, by the vibrational excitation of the screen.

The vibrational excitation of the first and/or second means of transport and/or metering, and/or of the screen, is not transmitted, or almost entirely not transmitted, to other equipment components by means of damping or compensating means. The method as described herein can preferably be operated with the mixing-metering device as described herein.

Simplified and efficient powder management is also achieved with the use of a first means of transport and/or metering designed as a vibrating channel or a vibrating duct for the transport of a first powder-form material, and at least one further, in particular a second, means of transport and/or metering, designed as a vibrating channel or a vibrating duct, for the transport of at least one further, in particular a second, powder-form material, according to claim 18. The means of transport and/or metering are used as metering and/or mixing means for the metering and/or mixing of the first and further, in particular a second, powder-form material, wherein the outlet of the first means of transport and/or metering is above the further, in particular the second, means of transport and/or metering, in particular above the outlet of the further, in particular the second, means of transport and/or metering, such that the first powder-form material enters or reaches the outlet of the further, in particular the second, means of transport and/or metering or enters into the region of the outlet of the further, in particular the second, means of transport and/or metering, in particular by falling into the latter.

Simplified and efficient powder management is also achieved with a method for the additive manufacture of a manufactured part by means of a powder or a powder mixture according to claim 19. In the method, provision is made that in a powder management process the powder or the powder mixture is provided and/or conveyed, wherein in a subsequent powder processing step the powder or the powder mixture is processed into the manufactured part by means of additive manufacture. The powder management process comprises a mixing/metering method as described herein, or is created from the latter.

Simplified and efficient powder management is further achieved with a powder mixture according to claim 20. The powder mixture comprises a first powder for an additive manufacturing process, and at least one further, in particular a second, powder for an additive manufacturing process. The powder mixture is produced with a mixing/metering device as described herein, in particular by means of a mixing/metering method as described herein.

In one aspect of the invention, there is provided a device (1) for the production, in particular the production and metering, of a powder mixture for an additive manufacturing process, wherein the powder mixture for the additive manufacturing process comprises a first powder arranged in a first container (2), and at least one further powder arranged in at least one further container, in particular a second powder arranged in a second container (2′), wherein in that an inlet of a first means of powder transport and/or metering (4) is arranged at the outlet (6) of the first container (2), and an inlet of a further, in particular a second, means of powder transport and/or metering (4′) is arranged at the outlet (6′) of the further, in particular the second, container (2′), in that the first powder can be supplied by means of the first means of transport and/or metering (4), and the further, in particular the second, powder can be supplied by means of the further, in particular the second, means of transport and/or metering (4′), in each case in a controlled manner, in particular in a controllable and/or regulatable manner, to at least one mixing container (5), preferably comprising at least one screen (10), and in that the outlet (7) of the first means of transport and/or metering (4) and the outlet (7′) of the further, in particular the second, means of transport and/or metering (4′), are arranged in or above the mixing container (5) above each other or next to each other, preferably above each other or next to each other and in each case above the screen (10).

In another aspect of the invention, there is provided a device (1) wherein the outlet (7) of the first means of transport and/or metering (4) is arranged above the further, in particular the second, means of transport and/or metering (4′), in particular above the outlet (7′) of the further, in particular the second, means of transport and/or metering (4′), such that the first powder in the mixing container (5) falls in a controllable manner, in particular in a controllable and/or a regulatable manner, onto the outlet (7′) of the further, in particular the second, means of transport and/or metering (4′), or into the region of the outlet (7′) of the further, in particular the second, means of transport and/or metering (4′).

In another aspect of the invention, there is provided a device (1) wherein the first and/or the further, in particular the second, means of transport and/or metering (4, 4′) is designed as a vibrating channel (4, 4′) or a vibrating duct, or as a vibrating metering channel or as a vibrating metering duct, or as a switchable valve, in particular one that can be operated in a timed manner.

In another aspect of the invention, there is provided a device (1) wherein the quantity of powder of the first powder supplied to the mixing container (5) can be controlled, in particular can be controlled and/or regulated, by the vibrational excitation of the first means of transport and/or metering (4), and in that the quantity of powder of the further, in particular the second, powder supplied to the mixing container (5) can be controlled, in particular can be controlled and/or regulated, by the vibrational excitation of the further, in particular the second, means of transport and/or metering (4′), independently of that of the first means of transport and/or metering (4).

In another aspect of the invention, there is provided a device (1) wherein at least one vibration-decoupling unit (13) is arranged upstream of, or at the inlet of, the first and/or a further, in particular a second, means of transport and/or metering (4, 4′), as viewed in the direction of transport.

In another aspect of the invention, there is provided a device (1) wherein at least one vibration-decoupling unit (13) is arranged behind, or at the outlet (7, 7′) of, the first and/or the further, in particular the second, means of transport and/or metering (4, 4′), as viewed in the direction of transport.

In another aspect of the invention, there is provided a device (1) wherein the screen (10) in the mixing container (5) is designed as a vibrating screen, which can be subjected to a vibrational excitation in a controllable manner, in particular in a controllable and/or regulatable manner.

In another aspect of the invention, there is provided a device (1) wherein the mixing container (5) has an outlet (11) for the powder mixture, in particular an outlet (11) for the powder mixture, and an oversize granulate outlet (12).

In another aspect of the invention, there is provided a device (1) wherein the first and/or the further, in particular the second, container (2, 2′) has a weighing device (14, 14′) for purposes of recording the weight of the container contents.

In another aspect of the invention, there is provided a device for the management of a powder or a powder mixture for the additive manufacture of a manufactured part, wherein the device comprises at least one powder conveying unit, which supplies the powder or the powder mixture to at least one container, and/or at least one powder processing unit, in which the powder or the powder mixture is processed by means of additive manufacture, characterized in that the powder conveying unit comprises or is created from a device (1) as discussed above.

In another aspect of the invention, there is provided a method for the production of a powder mixture comprising a first powder for an additive manufacturing process, and at least one further, in particular a second, powder for an additive manufacturing process, wherein the quantity of the first powder is controlled, in particular is controlled and/or regulated, by means of a first means of transport and/or metering, and the quantity of the further, in particular the second, powder is controlled, in particular is controlled and/or regulated, by means of at least one further, in particular a second, means of transport and/or metering, and wherein the outlet of the first means of transport and/or metering is arranged above the further, in particular the second, means of transport and/or metering, in particular above the outlet, or in the region of the outlet, of the further, in particular the second, means of transport and/or metering, such that the first and the further, in particular the second, powders enter in a controlled manner, in particular in a controlled and/or regulated manner, into a mixing container arranged below the outlet of the further, in particular the second, means of transport and/or metering, in particular such that they fall into the latter.

In another aspect of the invention, there is provided a method for the production of a powder mixture wherein the first and/or the further, in particular the second, means of transport and/or metering is/are designed as a vibrating channel or as a vibrating duct.

In another aspect of the invention, there is provided a method for the production of a powder mixture wherein the metering of the first and/or the further, in particular the second, powder is controlled, in particular is controlled and/or regulated, by the vibrational excitation of the first and/or a further, in particular a second, means of transport and/or metering.

In another aspect of the invention, there is provided a method for the production of a powder mixture wherein at least one screen, in particular at least one vibrating screen, is arranged in the mixing container.

In another aspect of the invention, there is provided a method for the production of a powder mixture wherein the mixing of the powders is controlled, in particular is controlled and/or regulated, by the vibrational excitation of the screen.

In another aspect of the invention, there is provided a method for the production of a powder mixture wherein a vibrational excitation of the first and/or further, in particular a second, means of transport and/or metering, and/or of the screen, is not, or is almost entirely not, transmitted, to other equipment components by means of damping or compensating means.

In another aspect of the invention, there is provided a method for the production of a powder mixture that uses a device (1) as described above and which device is operated as described above.

In another aspect of the invention, there is provided a use of a first means of transport and/or metering (4), designed as a vibrating channel (4) or a vibrating duct, for the transport of a first powder-form material, and also at least one further, in particular a second, means of transport and/or metering (4′), designed as a vibrating channel (4′) or a vibrating duct, for the transport of at least one further, in particular a second, powder-form material, as means of metering and/or mixing for purposes of metering and/or mixing the first and further, in particular a second, powder-form materials, wherein the outlet (7) of the first means of transport and/or metering (4) is arranged above the further, in particular the second, means of transport and/or metering (4′), in particular above the outlet (7′) of the further, in particular the second, means of transport and/or metering (4′), such that the first powder-form material enters into or onto the outlet (7′) of the further, in particular the second, means of transport and/or metering (4′), or into the region of the outlet (7′) of the further, in particular the second, means of transport and/or metering (4′), in particular enters therein by falling.

In another aspect of the invention, there is provided a method for the additive manufacture of a manufactured part by means of a powder or a powder mixture, wherein in a powder management process the powder or the powder mixture is provided and/or conveyed, wherein in a subsequent powder processing step the powder or the powder mixture is processed into the manufactured part by means of additive manufacture, and wherein the powder management process comprises a method as described above, or is created as described above.

In another aspect of the invention, there is provided a powder mixture comprising a first powder for an additive manufacturing process and at least one further, in particular a second, powder for an additive manufacturing process, wherein the powder mixture has been produced with a device (1) as described above and in particular by a method as described above.

The above-cited components, as well as the components claimed and described in the examples of embodiment, which are to be used in accordance with the invention, are not subject to any particular exceptions in terms of their size, design, choice of materials, and technical concept, so that the selection criteria of known art in the field of application can be applied without restriction.

Further details, features and advantages of the subject matter of the invention ensue from the subsidiary claims, as well as from the following description and the related figures, in which an example of embodiment of a device for the production/metering of a powder mixture is shown in an exemplary manner. Individual features of the claims or the forms of embodiment can also be combined with other features of other claims and other forms of embodiment.

### BRIEF DESCRIPTION OF THE FIGURES

In the figures:

FIG. 1 shows a device for the production/metering of a powder mixture in a side view,

FIG. 2 shows a device in accordance with FIG. 1 in a sectioned front view, and

FIG. 3 shows a device in accordance with FIGS. 1 and 2 in a perspective view.

### DETAILED DESCRIPTION OF EXAMPLES OF EMBODIMENT

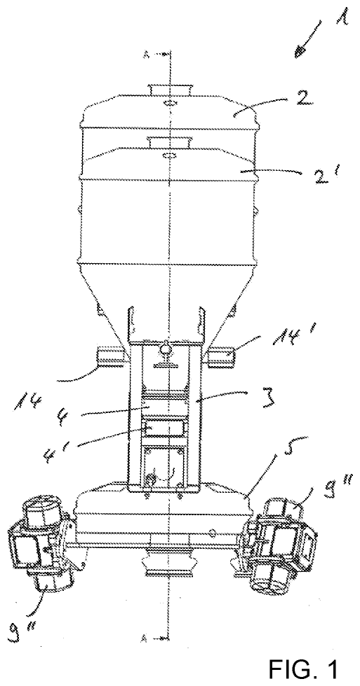

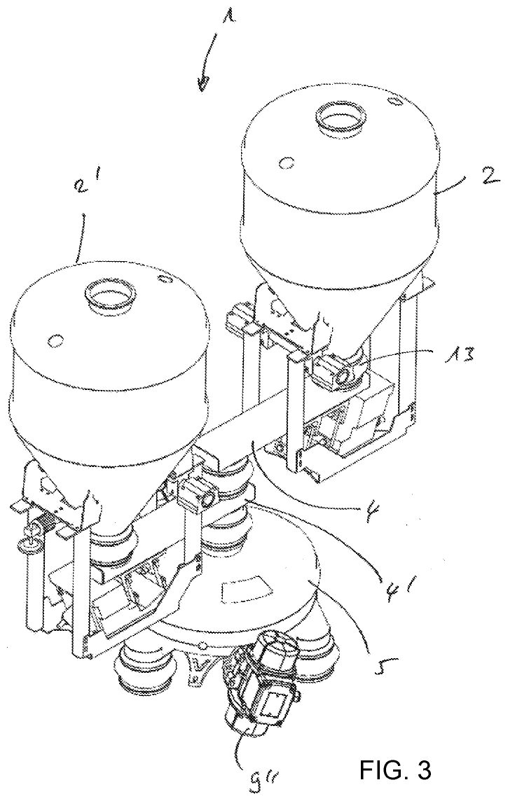

FIGS. 1 to 3 show a device 1 for the production of a powder mixture. The powder mixture is intended for an additive manufacturing process and can, for example, comprise, or be created from, a metal powder. The powder mixture is created from a first powder and from at least a second powder, or further powders. The first powder is arranged in a first container 2, and the second powder is arranged in a second container 2′. Further containers can be provided. FIGS. 1 to 3 show two containers 2, 2′ in an exemplary manner. Both containers 2, 2′ are fixed in a frame 3 of the device 1.

The first powder in the first container 2 can be a new powder, as offered and marketed by the powder manufacturer. The second powder in the second container 2′ can be a recycled powder, that is to say, a powder that has already been used once or several times in an additive manufacturing process, and which, for example, has remained as a residue or waste in the manufacturing process.

With the mixing device, recycled powder can be admixed with the new powder. The mixing ratio is specified by the user, in particular the user of the additive manufacturing process. For high quality processes, a mixing ratio of new/recycled powder of 100:1 can be provided, and for lower quality manufacturing specifications, a ratio of 10:1 or 2:1 can be specified.

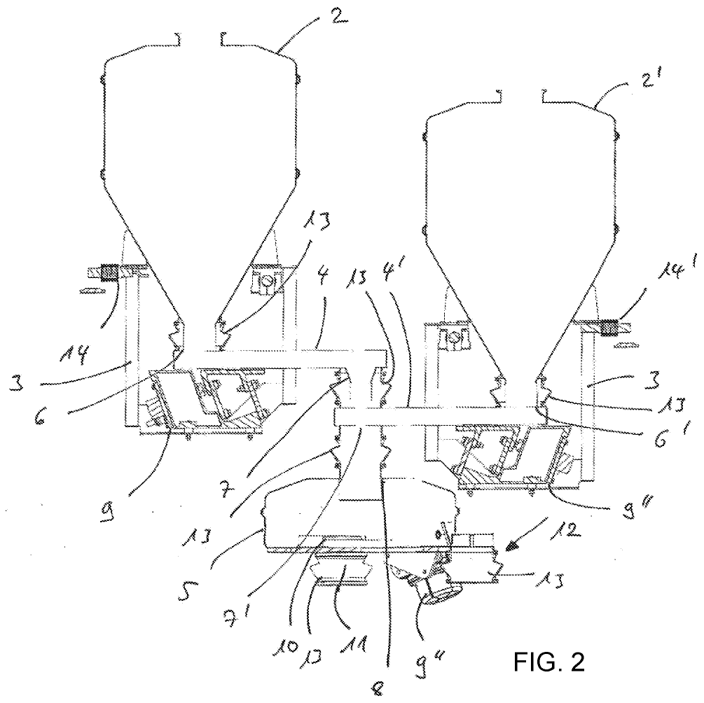

In order for the powder mixture to comply with the specifications, a mixing process that is as homogeneous as possible must be ensured. This is achieved with the device 1 in accordance with FIGS. 1 to 3, in that the powder mixture components are conveyed by means of the means of transport and/or metering 4, 4′ of the device 1, in a metered and controlled manner, into a mixing container 5. In accordance with FIG. 2 (a cross-section along AA, as shown in FIG. 1), the first powder reaches the first means of transport and/or metering 4 via the container outlet 6 and from there, via the means of transport and/or metering outlet 7, enters into the inlet 8 of the mixing container 5. The second powder reaches the mixing container 5 via the second means of transport and/or metering 4′. Both means of transport and/or metering 4, 4′ are designed as vibrating channels 4, 4′. Each vibrating channel 4, 4′ has its own vibrational excitation by means of a vibrating or out-of-balance motor 9, 9′. Each vibrating motor 9, 9′ can be controlled separately. The device 1 can be operated such that only channel 4 vibrates, so that only the first powder is metered into the mixing container 5, or such that only channel 4′ vibrates, so that only the second powder enters into the mixing container 5. Both channels 4, 4′ can also vibrate, so that both the first and second powders are metered into the mixing container 5. The proportion of the first (or second) powder in the powder mixture can thus be varied in a controlled manner in a range from 0%, or almost 0%, up to 100%, or almost 100%.

By control/regulation of the vibrational excitation, the material transport within the vibrating channels 4, 4′ becomes controllable and/or regulatable. If, for example, the first powder is to be conveyed at a comparatively high material flow rate, the first vibrating motor 9 applies a strong vibration to the first channel 4, and if the material flow rate of the second powder is to be lower than that of the first powder, the second vibrating motor 9′ applies a weaker vibrational excitation to the second channel 4′. If the material flow rate in a duct 4, 4′ is to be halted, the respective out-of-balance motor 9, 9′ is stopped.

The outlet 7 of the first means of transport and/or metering 4 is located vertically above the outlet 7′ of the second means of transport and/or metering 4′, as shown in FIG. 2. It can also be seen from FIG. 2 that the first container 2 is arranged somewhat higher in the frame 3 of the device 1 than the second container 2′. Thus, to an extent, the first powder falls into the transport or conveying path of the (falling) second powder. From the transport path outlets 7, 7′ the powders enter onto the surface of a screen 10 in the mixing container 5. The screen 10 can be excited into vibration by means of an out-of-balance motor 9″, so that the powders on the screen 10 are homogeneously mixed on the one hand, and so that accumulations of material in the mixing container 5 are avoided on the other. The mixing container 5 has a correctly-sized granulate outlet 11, from which the powder mixture leaves the device 1, and a coarse granulate outlet 12, by means of which lumps or impurities in the powders are screened out of the mixture.

Compensators 13 are arranged between the components (4, 4′, 10) that can be subjected to vibration, which compensators dampen the vibrations and help to ensure that vibrations are not transmitted to other components, or only to a limited extent. Thus, a compensator 13 is located between the first container 2 and the first means of transport and/or metering 4, and between the second container 2′ and the second means of transport and/or metering 4′, also between the first means of transport and/or metering 4 and the second means of transport and/or metering 4′ on the outlet side, and between the second means of transport and/or metering 4′ and the mixing container 5. Further compensators 13 can be arranged on the outlet side of the mixing container 5.

To monitor the quantity of powder in the containers 2, 2′, weighing units 14, 14′ are provided on the first and second container, with which the absolute container weight or an alteration in weight can be observed.

### LIST OF REFERENCE SYMBOLS

1 Powder mixing device
2, 2′ Container
3 Frame
4, 4′ Means of transport and/or metering, vibrating channel
5 Mixing container
6, 6′ Container outlet
7, 7′ Means of transport and/or metering outlet
8 Mixing container inlet
9, 9′, 9″ (Out-of-balance) motor, vibrating motor
11 Correctly-sized granulate outlet
12 Coarse granulate outlet, oversize granulate outlet
13 Compensator, vibration-decoupling unit
14, 14′ Weighing unit

1. Device for the production, in particular the production and metering, of a powder mixture for an additive manufacturing process, wherein the powder mixture for the additive manufacturing process comprises a first powder arranged in a first container, and at least one further powder arranged in at least one further container, in particular a second powder arranged in a second container, characterized:
in that an inlet of a first means of powder transport and/or metering is arranged at the outlet of the first container, and an inlet of a further, in particular a second, means of powder transport and/or metering is arranged at the outlet of the further, in particular the second, container,
in that the first powder can be supplied by means of the first means of transport and/or metering, and the further, in particular the second, powder can be supplied by means of the further, in particular the second, means of transport and/or metering, in each case in a controlled manner, in particular in a controllable and/or regulatable manner, to at least one mixing container, preferably comprising at least one screen, and
in that the outlet of the first means of transport and/or metering and the outlet of the further, in particular the second, means of transport and/or metering, are arranged in or above the mixing container above each other or next to each other, preferably above each other or next to each other and in each case above the screen.

2. Device according to claim 1, characterized in that the outlet of the first means of transport and/or metering is arranged above the further, in particular the second, means of transport and/or metering, in particular above the outlet of the further, in particular the second, means of transport and/or metering, such that the first powder in the mixing container falls in a controllable manner, in particular in a controllable and/or a regulatable manner, onto the outlet of the further, in particular the second, means of transport and/or metering, or into the region of the outlet of the further, in particular the second, means of transport and/or metering.

3. Device according to claim 1, characterized in that the first and/or the further, in particular the second, means of transport and/or metering is designed as a vibrating channel or a vibrating duct, or as a vibrating metering channel or as a vibrating metering duct, or as a switchable valve, in particular one that can be operated in a timed manner.

4. Device according to claim 3, characterized in that the quantity of powder of the first powder supplied to the mixing container can be controlled, in particular can be controlled and/or regulated, by the vibrational excitation of the first means of transport and/or metering, and in that the quantity of powder of the further, in particular the second, powder supplied to the mixing container can be controlled, in particular can be controlled and/or regulated, by the vibrational excitation of the further, in particular the second, means of transport and/or metering, independently of that of the first means of transport and/or metering.

5. Device according to claim 1, characterized in that at least one vibration-decoupling unit is arranged upstream of, or at the inlet of, the first and/or a further, in particular a second, means of transport and/or metering as viewed in the direction of transport.

6. Device according to claim 1, characterized in that at least one vibration-decoupling unit is arranged behind, or at the outlet of, the first and/or the further, in particular the second, means of transport and/or metering, as viewed in the direction of transport.

7. Device according to claim 1, characterized in that the screen in the mixing container is designed as a vibrating screen, which can be subjected to a vibrational excitation in a controllable manner, in particular in a controllable and/or regulatable manner.

8. Device according to claim 7, characterized in that the mixing container has an outlet for the powder mixture, in particular an outlet for the powder mixture, and an oversize granulate outlet.

9. Device according to claim 1, characterized in that the first and/or the further, in particular the second, container (2, 2′) has a weighing device (14, 14′) for purposes of recording the weight of the container contents.

10. Device for the management of a powder or a powder mixture for the additive manufacture of a manufactured part, wherein the device comprises at least one powder conveying unit, which supplies the powder or the powder mixture to at least one container, and/or at least one powder processing unit, in which the powder or the powder mixture is processed by means of additive manufacture, characterized in that the powder conveying unit comprises or is created from a device (1) according to claim 1.

11. Method for the production of a powder mixture comprising a first powder for an additive manufacturing process, and at least one further, in particular a second, powder for an additive manufacturing process, wherein the quantity of the first powder is controlled, in particular is controlled and/or regulated, by means of a first means of transport and/or metering, and the quantity of the further, in particular the second, powder is controlled, in particular is controlled and/or regulated, by means of at least one further, in particular a second, means of transport and/or metering, and wherein the outlet of the first means of transport and/or metering is arranged above the further, in particular the second, means of transport and/or metering, in particular above the outlet, or in the region of the outlet, of the further, in particular the second, means of transport and/or metering, such that the first and the further, in particular the second, powders enter in a controlled manner, in particular in a controlled and/or regulated manner, into a mixing container arranged below the outlet of the further, in particular the second, means of transport and/or metering, in particular such that they fall into the latter.

12. Method according to claim 11, wherein the first and/or the further, in particular the second, means of transport and/or metering is/are designed as a vibrating channel or as a vibrating duct.

13. Method according to claim 12, wherein the metering of the first and/or the further, in particular the second, powder is controlled, in particular is controlled and/or regulated, by the vibrational excitation of the first and/or a further, in particular a second, means of transport and/or metering.

14. Method according to one of the claim 11, wherein at least one screen, in particular at least one vibrating screen, is arranged in the mixing container.

15. Method according to claim 14, wherein the mixing of the powders is controlled, in particular is controlled and/or regulated, by the vibrational excitation of the screen.

16. Method according to claim 11, wherein a vibrational excitation of the first and/or further, in particular a second, means of transport and/or metering, and/or of the screen, is not, or is almost entirely not, transmitted, to other equipment components by means of damping or compensating means.

17. Method according to claim 11, with which a device is operated said device for the production, in particular the production and metering, of a powder mixture for an additive manufacturing process, wherein the powder mixture for the additive manufacturing process comprises a first powder arranged in a first container, and at least one further powder arranged in at least one further container, in particular a second powder arranged in a second container.

18. Use of a first means of transport and/or metering, designed as a vibrating channel or a vibrating duct, for the transport of a first powder-form material, and also at least one further, in particular a second, means of transport and/or metering, designed as a vibrating channel or a vibrating duct, for the transport of at least one further, in particular a second, powder-form material, as means of metering and/or mixing for purposes of metering and/or mixing the first and further, in particular a second, powder-form materials, wherein the outlet of the first means of transport and/or metering is arranged above the further, in particular the second, means of transport and/or metering, in particular above the outlet of the further, in particular the second, means of transport and/or metering, such that the first powder-form material enters into or onto the outlet of the further, in particular the second, means of transport and/or metering, or into the region of the outlet of the further, in particular the second, means of transport and/or metering, in particular enters therein by falling.

19. Method for the additive manufacture of a manufactured part by means of a powder or a powder mixture, wherein in a powder management process the powder or the powder mixture is provided and/or conveyed, wherein in a subsequent powder processing step the powder or the powder mixture is processed into the manufactured part by means of additive manufacture, and wherein the powder creation or powder management process comprises a method according to claim 11.

20. Powder mixture comprising a first powder for an additive manufacturing process and at least one further, in particular a second, powder for an additive manufacturing process, characterized in that the powder mixture has been produced with a device according to claim 1.
